(19) United States
(12) Patent Application Publication
(10) Pub. No.: US 2009/0018899 A1
(43) Pub. Date: Jan. 15, 2009

(54) User collaboration system and server

(75) Inventors: Minoru Ogushi, Kodaira (JP); Keiro Muro, Koganei (JP); Norihiko Moriwaki, Hino (JP); Toshiyuki Odaka, Fuchu (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/068,824

(22) Filed: Feb. 12, 2008

(30) Foreign Application Priority Data
Jul. 11, 2007 (JP) 2007-182291

(51) Int. Cl. G06Q 10/00

(52) U.S. Cl. 705/11

(57) ABSTRACT

There is provided a facile sound communication tool that can quickly communicate with a necessary partner when needed. The real-time contexts of users are detected from sensors that are worn by the users, and diverse sensors that are located around the respective users to obtain data. The data is transmitted to a server. A context analyzer of a processor in the server determines the busyness of the respective users on the basis of the data, and a collaboration controller controls a communication between the respective users on the basis of the busyness.

### CLAIM OF PRIORITY

The present application claims priority from Japanese application JP 2007-182291 filed on Jul. 11, 2007, the content of which is hereby incorporated by reference into this application.

### BACKGROUND OF THE INVENTION

The present invention relates to a user collaboration technique that contributes to an improvement in the productivity of organizational task.

Up to now, as seen in JP-A No. 2007-108813, for example, an attempt has been made to improve the efficiency of the organizational task by the aid of a communication within an organization using a sensor node.

### SUMMARY OF THE INVENTION

In a large number of tasks such as product development, system integration, and consulting, close collaboration between members is essential in order to smoothly execute the tasks.

In a large number of organizational tasks including elements such as negotiation or adjustment, the task execution between the respective members has a dependent execution, and the dependent relation asynchronously occurs and changes. It is necessary that the dependent relation is adjusted and solved by the communication between the members.

The most direct communication is a meeting that is conducted face to face. However, when there is a distance between the members, or when it is not temporally convenient to the members, it is difficult to conduct the communication face to face. In this scene, there are used diverse telecommunication means such as fixed telephone as well as cellular phone, e-mail, instant messenger, or web log.

However, the quantity and quality of the communication are insufficient in the execution of the collaboration task.

In the task spot, the respective members have the corresponding tasks in charge, and autonomously execute the main portions thereof. For that reason, the detailed context of the task is asynchronously and continuously updated, and the dependent relation is also continuously updated. Accordingly, in order to excellently execute the collaboration tasks as a whole, it is necessary that the respective members continuously grasp the updated context of the dependent relation related to a subject task in charge. To achieve this, it is essential to advance the transmission and sharing of the information by conducting a close communication with the related member.

However, the conventional telecommunication technique cannot sufficiently achieve the effect of advancing the transmission or the sharing of the information in a timely fashion in the organizational collaboration task that is asynchronously executed. As a result, the communication of the quality and quantity sufficient to make the above collaboration task succeed cannot be maintained, and such a context that the entire collaboration task does not make a desired progress often occurs.

Also, the sufficient communication is conducted on the direct collaboration that is high in the necessity, and there are many cases in which many pieces of potential information that has not been transmitted or shared actually exists even when the entire collaboration task is seemingly executed with a sufficient performance. For example, there is a context in which such a fact that two members who have not collaborated with each other have knowledge or an idea which is useful in the respective members is revealed later.

Under the above circumstances, the present applicant has proposed a support system activates a communication within a task organization by the aid of a sensor node so as to realize the strengthened collaboration between the members (operators) as disclosed in JP-A No. 2007-108813. However, it is necessary to designate whether a contact with the related member is enabled, or not, before the operation starts, and consideration in quickness, facility, and real time property are insufficient.

The present invention has been made in view of the above circumstances, and therefore an object of the present invention is to provide a user collaboration system that can quickly communicate with a necessary partner when needed in the spot of the collaboration task, and presents the potential collaboration information to the user in real time, and a device for the system.

In order to achieve the above object, according to the present invention, there is provided a user collaboration system including: means for detecting the real-time contexts of respective users from sensors that are worn by the users or a large number of diverse sensors that are located around the users; means for determining the busyness of the respective users on the basis of the user contexts; and means for controlling a communication between the respective users on the basis of the busyness.

According to the present invention, there is preferably provided a user collaboration system that realizes a communication between plural users, the user collaboration system including a detector that detects the user contexts of respective users in real time, and a processor that determines the busyness of tasks of the respective users based on the user contexts detected by the detector, wherein the communication between the users is controlled on the basis of the determined busyness.

According to the present invention, there is preferably provided a user collaboration system that realizes communications between plural users, including plural sensor nodes that detect the user contexts of respective users; a server including a communication portion, a memory, and a processor, which is connected to the sensor nodes on a network, wherein the server receives the user contexts of the respective users by the communication portion and stores the user contexts in the memory, and determines the busyness of tasks engaged by the users in the processor on the basis of the received user contexts so that the user collaboration system and the server device control the communication between the users is controlled on the basis of the determined busyness.

According to the present invention, there can be provided a facile communication system that can quickly communicate with a necessary partner when needed in a task spot.

### BRIEF DESCRIPTION OF THE DRAWINGS

FIG. 1 is a diagram showing the entire structure of a user collaboration system according to a first embodiment;

FIGS. 2A to 2C are diagrams showing the definition contents of a model definition in the first embodiment in which FIG. 2A is a diagram showing a definition of the correspondence between real objects and models, FIG. 2B is a diagram showing a definition of how mutual proximity relations should be analyzed between symbolic types, and FIG. 2C is a diagram showing a definition based on an IF-THEN rule for deriving task information in the task on the basis of the proximity relation of the systematic object or the systematic type.

FIGS. 3A and 3B are diagrams showing a procedure (relation analyzing flow) that is executed by a model analyzer in the first embodiment, in which FIG. 3A is a flowchart showing a general processing flow, and FIG. 3B is a flowchart showing an example of real processing of specific input data;

FIG. 4 is a diagram for explaining the detail estimation of a user behavior by a behavior analyzer in the first embodiment;

FIG. 5 is a diagram for explaining the keyword detection by a keystroke analyzer in the first embodiment;

FIG. 6 is a diagram for explaining a method of calculating the busyness in the first embodiment;

FIG. 7 is a diagram showing time series context information that is stored in a context base in the first embodiment;

FIG. 8 is a diagram showing a partners' context acquiring flow by a user in the first embodiment;

FIG. 9 is a diagram showing a reservation flow until the reservation of a communication partner has been completed in the first embodiment;

FIG. 10 is a diagram showing an establishment flow of a reservation session in the first embodiment; and

FIG. 11 is a diagram for explaining the find and presentation of a potential collaboration partner by a system in a second embodiment.

### DETAILED DESCRIPTION OF THE INVENTION

Hereinafter, a description will be given of embodiments of the present invention with reference to the attached drawing.

### First Embodiment

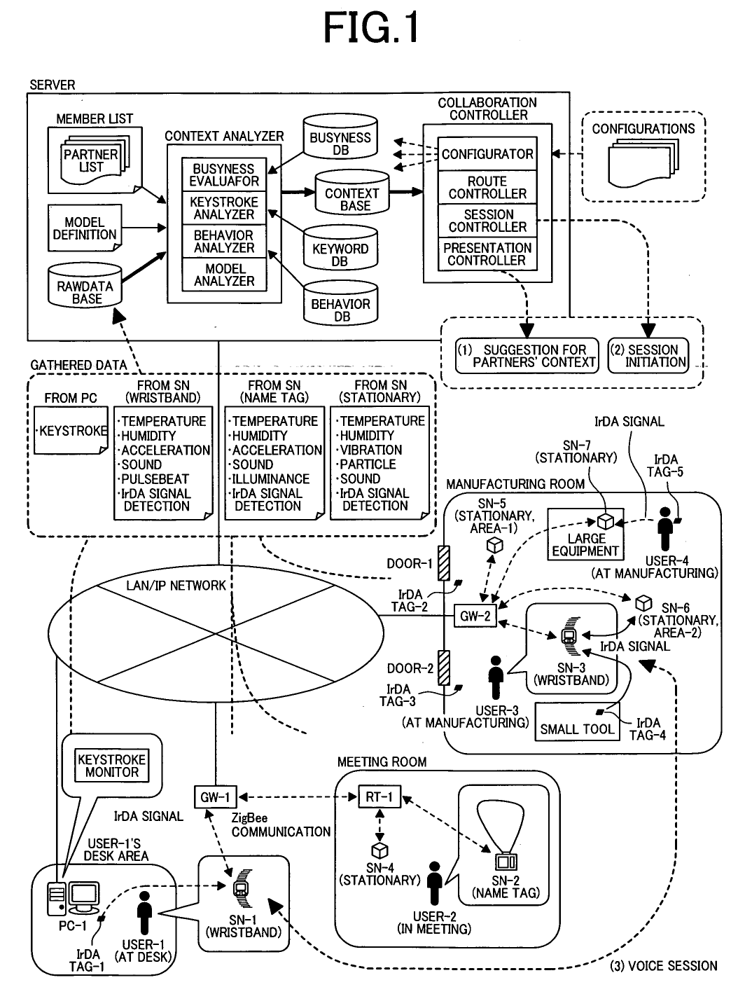

FIG. 1 is a structural diagram showing an entire user collaboration system according to a first embodiment. This system is applied in an office environment including a deskwork space, a meeting room, and an operation room. Four users (user-1, user-2, user-3, and user-4) exist within an area shown in the figure. The user user-1 is at his desk or in a user-1's desk area, and is at desk. The user user-2 is in the meeting room, and is in a meeting. The user user-3 and the user user-4 are in a manufacturing room, and are at manufacturing.

A backend portion of the system (a portion that conducts communication inflation and data processing) is made up of one server, IP (internet protocol) network (LAN/IP network) such as a local area network (LAN), base station devices GW-1 and GW-2 of a ZigBee communication (ZigBee is registered trademark) having a communication interface with the IP network, and a router device RT-1 of the ZigBee communication for enlarging a communication area of the ZigBee radio when needed.

A front end portion of the system (a portion that generates data and supplies an interface with the user) is made up of wearable sensor nodes SN-1, SN-2, and SN-3 such as wrist bands or name tags which are attached to the respective users, stationary sensor nodes SN-4, SN-5, and SN-6 which are located at appropriate positions of the office environment, small tags (IrDA, tag-1, IrDA tag-2, IrDA tag-3, IrDA tag-4, IrDA tag-5, IrDA tag-6) that periodically transmit their identifying signals (IrDA signal) by IrDA communication, and a key stroke monitor that is a software for recording a keystroke that has been installed in a deskwork personal computer PC-1 of the user user-1.

Diverse sensors are incorporated in the sensor nodes SN-1 to SN-6, which transmit measurement information periodically sensed by the aid of the ZigBee communication in real time. Data that has been transmitted by the sensors of the sensor nodes SN-2 and SN-4 is routed through the router RT-1. Further, the data is routed through the IP network from the base station device so as to be gathered in the server. Those sensor nodes SN have radio communication means of IrDA, which can detect an IrDA signal that is transmitted by another sensor node or small tag (IrDA tag) which exists at a short distance. The detection information of the IrDA signal is transmitted by the aid of the ZigBee communication as with the above-mentioned sensor measurement information, and gathered in the server.

Also, the keystroke monitor that has been installed in the PC-1 records the input key character string that has been input to the deskwork where the user user-1 uses the PC-1, and transmits the keystroke to the server in real time.

The information that is obtained by the sensors that are incorporated into the wearable sensor nodes SN-1, SN-2, and SN-3 can be regarded as environmental information or biologic information related to the user having the sensor node. For example, in the wrist band sensor node SN-1 that is worn by the user user-1, the environmental temperature or the environmental humidity of the user-1's desk area are obtained by a temperature/humidity sensor mounted on a front surface of the sensor node SN-1. On the other hand, the biologic information such as the body temperature or the amount of sweating of the user user-1 is obtained by the temperature/humidity sensor that is mounted on a rear surface of the sensor node SN-1.

The information that is obtained by the sensors that are incorporated into the stationary sensor nodes SN-4, SN-5, and SN-6 can be regarded as environmental information related to locations where the sensor nodes are installed. For example, in the stationary sensor node SN-4 that is installed within the meeting room, the environmental temperature or the environmental humidity within the meeting room is obtained by the temperature/humidity sensor, and sounds in a meeting which is conducted within the meeting room are obtained by a microphone (sound sensor). On the other hand, in large equipment that is always running within the manufacturing room, the equipment temperature or the equipment humidity is obtained by the temperature/humidity sensor, and the device vibrations are obtained by a vibration sensor.

As described above, the sensor nodes are located on the person, the location, or the object which is main in the office environment, and the diverse measurement information is obtained and gathered in the server in real time, thereby getting raw data that is a material for estimating the context information related to the task. The server has the structure of the normal computer device, and includes a central processing unit (CPU) that is a processing unit, a memory such as a semiconductor memory or a hard disk drive (HDD), an input/output portion, and a communication portion that transmits or receives data on the IP network.

In FIG. 1, as an example of the gathered data, the keystroke information is shown as the data from the personal computer (PC), temperature information, humidity information, acceleration information, sound information (sound), pulse beat information, the IrDA signal detection information, illuminance information, vibration information, and particle detection information are shown as information from the sensor node (SN).

The sensor measurement information, the detection information of the IrDA signal, and the keystroke information are gathered in the server as the raw data for estimating the task behaviors of the respective users, and first stored in a raw data base that is stored in the memory of the server.

A context analyzer calculates the context information including the tasks and the busyness of the respective users on the basis of the information that is input to the raw data base in real time as well as information on a predetermined member list, a model definition, a behavior database (DB), a keyword database (DB), and a busyness database (DB), and stores the context information in the context base. As will be described later, the above processing is realized by a model analyzer, a behavior analyzer, a keystroke analyzer, and a busyness evaluator within the context analyzer.

The above respective databases such as the member list, the model definition, or the behavior DB, and the context base are stored in the memory within the server or an external memory as with the raw data base. Also, the model analyzer, the behavior analyzer, the keystroke analyzer, and the busyness evaluator which are the respective functional blocks that constitute the context analyzer are constituted as program processing or partial hardware which is executed by the CPU which is a processor in the server. In both of those cases, the function of the context analyzer is the function of the processor.

As described above, the server faces the situation in which the server calculates the real-time context information of the respective users on the basis of the diverse data that has been received from the front end portion of the system in this embodiment and gathered. Under the situation, the respective users autonomously execute their tasks, but there occurs the necessity that one user communicates with another user according to the situation of the task. However, when the user user-1 intends to communicate with the user user-3, the user user-3 may not always at his desk, and at that time, the user user-3 may be unable to be contacted by phone. Even if the communication is conducted, the communication may not be preferable because the user user-3 may now be executing a task that is higher in priority than other tasks. That is, a time when the user intends to make a communication is not always the best timing for both of the user and the partner.

In the user collaboration system according to this embodiment, the server that grasps the task contexts of the respective users in real time presents the real-time task context of the partner, the timing that is convenient for both of the user and the partner, and the partner who is potentially higher in the relation with the user, thereby making it possible that the user communicates with the partner at better timing with the presented information as a trigger. As a result, the sharing and collaboration of the information as the entire organization become intense, and help to improve the productivity of the organizational task.

As specific communicating means between the users, in this embodiment, a case of using a radio sound calling function provided in the wearable sensor nodes (SN-1, SN-2, and SN-3) which are worn by the respective users will be mainly described. That is, the respective users user-1, user-2, and user-3 wear the wearable sensor nodes SN-1, SN-2, and SN-3 having the radio sound calling function, respectively. When the user user-1 and the user user-2 communicate with each other, a sound communication starts between the sensor node SN-1 and the sensor node SN-2, and when the user user-1 and the user user-3 communicate with each other, a sound communication starts between the sensor node SN-1 and the sensor node SN-3.

In this situation, a collaboration controller within the server presents the task context of the communication partner, and executes the start of the sound communication and a route control required in this situation. As will be described later, the collaboration controller is made up of the respective functional blocks of a configurator, a route controller, a session controller, and a presentation controller. Those functional blocks are constituted by program processing that is executed by a CPU that is a processor within the server, or a partial hardware as with the respective functional blocks of the context analyzer. The function of the collaboration controller is a function of the processor.

The wearable sensor nodes SN-1 and SN-3 are shaped in a wrist band, and the sensor node SN-2 is shaped in a name tag. Because the sensor nodes of the wrist band type and the name tag type are slightly different in not only the configuration but also the installation morphology, the calling morphology, and the incorporated sensor, it is possible to select any one of the wrist band type and the name tag type to be used on the basis of whether the sensor node is impeditive during task, or not, or whether the server can calculate the context information with higher precision, or not. For example, in the case of the user user-3 who is engaged in the manufacturing task, the user frequently conducts the work in only a bent-over position, and the sensor node of the name tag type that is worn around user's neck may interfere with the operation. In this case, it is suitable to wear the sensor node of the wrist band type which is fixed to a given position of his wrist or arm. Also, in the case of a specific operation environment such that the user employs fire or water, or enters a very narrow place, both of the name tag type sensor node and the wrist band type sensor node may interfere with the operation (user user-4).

In the above case, the user can wear a small tag (IrDA tag-5) that is further smaller and difficult to interfere with the operation instead of the sensor node. Since it is detected that the user user-5 exists close to a stationary sensor node SN-7 by the virtue of the IrDA signal transmission function of the small tag (IrDA tag-5), the measurement information of the sensor node SN-7 can be regarded as the environmental information related to the user user-4, and the user user-4 can employ the radio sound calling function that is disposed in the sensor node SN-7 instead of the wearable sensor node in order to communicate with another user.

In this system, as another communicating means that can be readily applied in the communication between the users, there are proposed an IP phone or messenger software on a PC. Those means are constituted on a common protocol that is called “IP (internet protocol)”, the specification is open, and the developmental environment for conducting the collaboration or extension are put into place. In the case of the fixed phone or the cellular phone, the specification is closed, and those phones are inferior in the convenience because a dedicated device for mutual connection is required. However, there is essentially no change in that those phones can be utilized as the communicating means used in this embodiment.

In the case where the user user-1 operates the sensor node SN-1 in order to contact with the user user-3, in the system according to this embodiment presents, as a pre-stage procedure (1) that actually establishes the sound communication between the sensor node SN-1 and the sensor node SN-3, a presentation controller presents the context information on the user user-3 to the sensor node SN-1 (suggestion for partners' context) on the basis of the real-time context information that is input to the context base as described above. With the above operation, the user user-1 can determine whether it is proper to communicate with the user user-3 at that time point, or not. When not proper, the user user-1 can wait for a notification that proper timing comes from the presentation controller.

Then, at a time point when the user user-1 actually determines that he makes a communication, a voice session between the sensor node SN-1 and the user user-3 is initiated by a session controller as another procedure (2) (session initiation). In this way, the voice session of the procedure (3) is finally established to conduct an actual call between the user user-1 and the user user-3. Also, a control for establishing a communication between the sensor node SN-1 and the server and a communication between the sensor node SN-1 and the sensor node SN-3 in the sequence of procedure is conducted by the route controller by the aid of the identification information on the respective sensor nodes and the normal route control protocol, and therefore its description will be omitted.

The configurator receives the diverse configurations from the user or a manager, and reflects the diverse configurations on the respective functional portions. The configurations are, for example, the registration or change of a member list, a model definition, a behavior database (DB), a keyword database (DB), or the busyness database (DB) by the system manager, and the registration or change of a partner list by the respective users. Hereinafter, those respective diverse configurations will be described with reference to the accompanying drawings.

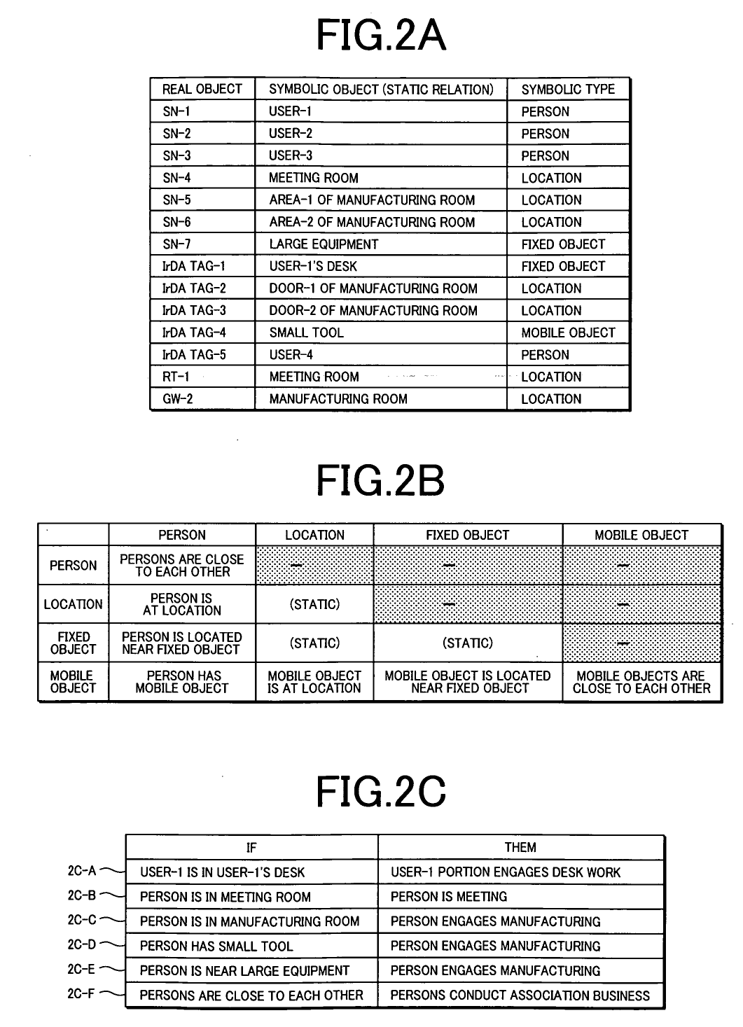

FIGS. 2A to 2C show the definition contents of the model definition. In order to calculate the context information such as the task contexts of the respective users from the raw data that is input to the raw data base, it is necessary that an object or a matter which is related to the task that exists in the office environment is modeled to relate the raw data to the models. The definition collection for achieving this is a model definition.

FIG. 2A shows the definition of relations of the real object to the models. In the real object are registered the respective devices that are the structural elements of the system such as the sensor node (SN) or the small tag (IrDA tag), and in a symbolic object are indicated what is a real object that is conceptually represented by the device. Further, in the symbolic type are indicated classifications representative of the type of the conceptual real object. For example, the sensor node SN-1 as the real object is representative of the user user-1 as the symbolic object, and its type is a person. The sensor node SN-1 that is worn by the user user-1 is dealt with as a symbolic object of the user user-1 on the model by this definition. That is, a position where the sensor node SN-1 exists is a position where the user user-1 exists, and it can be interpreted that the measurement information that is transmitted to the server from the sensor node SN-1 is information related to the behavior of the user user-1 or the environment that surrounds the user user-1.

The information on positions at which the respective users exist or a proximity relation of the user to another user or the object is information that plays a very important role in calculating the context information on the respective users. In this embodiment, the sensor node and the small tag (IrDA-tag) have proximity communication means. The sensor node detects the information on the IrDA signal that is transmitted by the small tag (IrDA-tag) or another sensor node, thereby making it possible to obtain the information on the above proximity relation very efficiently and in real time. The proximity relation between the real objects such as the sensor node or the small tag (IrDA tag) can be replaced with the proximity relation between the symbolic objects by using FIG. 2A. In this example, the proximity relation between the symbolic objects is different in the specific interpretation according to the relation between the types.

FIG. 2B shows a definition of how the mutual proximity relation should be interpreted between the symbolic types shown in FIG. 2A. For example, the proximity of the respective persons literally represents that “the persons are close to each other”, and the proximity of the person and the location represents that “the person exists at the location”. Also, the proximity relation between the person and the fixed object represents the context that “the person exists close to the fixed object” since the fixed object does not travel. On the other hand, in the case of the proximity relation between the person and the mobile object, because both of the person and the mobile object are objects that travel, which of those objects should be main in the definition of the positional relation depends on the context. In this example, it is assumed that the mobile object is a tool that is carried by the person, that the person carries the mobile object is defined.

Those proximity relations represent the contexts related to the location of the symbolic object as itself, and the proximity relation can be interpreted as the contexts having the higher association with the task contents. FIG. 2C shows a definition based on the IF-THEN rule for deriving the task information on the task on the basis of the proximity relation of the symbolic object or the symbolic type. For example, when the user user-1 exists close to his desk, it can be interpreted that the user user-1 is at his desk (2C-A). Also, when a person exists at the meeting room, it can be interpreted that the person is at meeting room (2C-B). Hereinafter, 2C-C to 2C-F can be interpreted as shown in FIG. 2C.

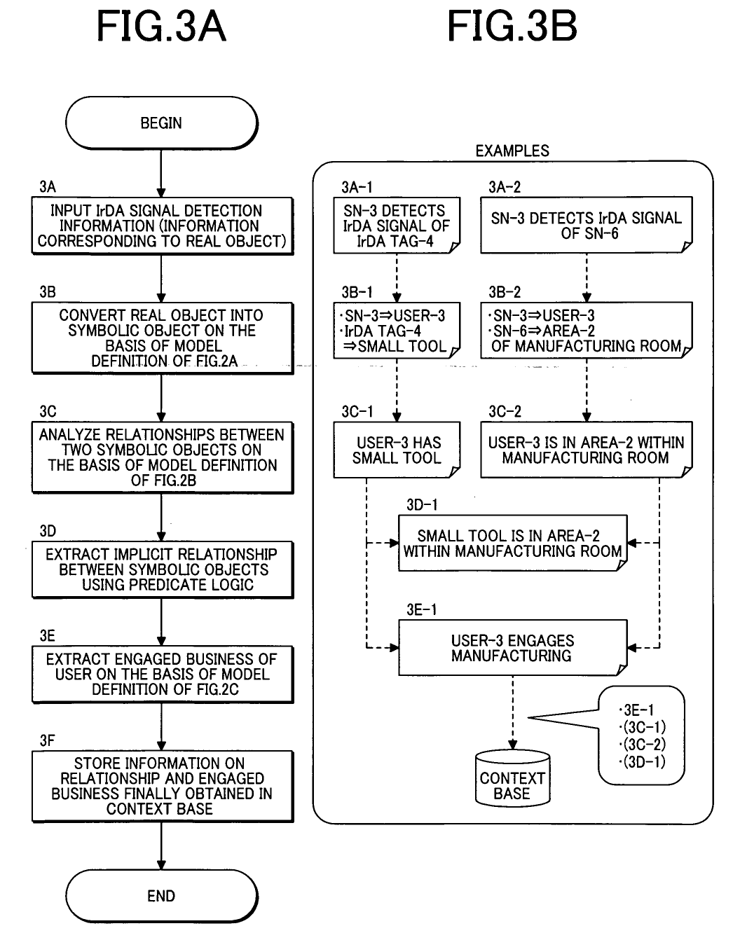

The model analyzer within the context analyzer interprets the association between the symbolic objects by the aid of the model definition shown in FIGS. 2A to 2C, and finally derives the information related to the contents of the task of the user. FIGS. 3A and 3B show procedures that are executed by the model analyzer, that is, the association analysis flows, in which FIG. 3A shows a general processing flow, and a portion surrounded by dotted lines in FIG. 3B shows an example of actual processing with respect to specific input data.

Referring to FIG. 3A, the model analyzer is input with information of the IrDA signal that is detected by the sensor node as information corresponding to the real object (3A). More specifically, as shown in FIG. 2B, the input information is information (3A-1) that “SN-3 detects the IrDA signal of the IrDA tag-4”, or information (3A-2) that means that SN-3 detects the IrDA signal of the SN-6. When the input information is represented by the level of format, the information includes, for example, a first field indicative of the detection information of the IrDA signal, a second field that regulates the detection subject, and a third field that regulates an object to be detected. In the case of the information 3A-1, a value of the second field is identification information representative of the sensor node SN-3, and a value of the third field is identification information representative of the small tag IrDA tag-4.

After the IrDA signal detection information has been input, the model analyzer first converts the information on the real object into information on the symbolic object that is meant by the information on the real object according to the definition shown in FIG. 2A (3B). More specifically, the identification information representative of the sensor node SN-3 included in the input information 3A-1 is converted into identification information representative of the information on the user user-3, and the identification information representative of the small tag IrDA tag-4 is converted into the identification information representative of the small tool. The same is applied to the input information 3A-2 (3B-2).

Subsequently, the model analyzer reinterprets the proximity relation between the symbolic objects as a relation including a positional relation and a master-servant relation on the basis of the relation between the symbolic types according to the definition shown in FIG. 2B (3C). As a result, the input information 3A-1 is reinterpreted to the relation information that “the user-3 has the small tool” (3C-1), and the input information 3A-2 is reinterpreted to the relation information that “the user-3 is within an area-2 in the manufacturing room” (3C-2).

When there are plural pieces of input information, there is a case in which the dependent relation exists between the relation information and the symbolic objects. In this case, a predicate logic manner is used to extract the implicit relation information that is derived indirectly from the plural pieces of relation information (3D). For example, the implicit relation information 3D-1 related to the location of the small tool can be derived from the relation information 3C-2 and the relation information 3C-1.

Further, the respective relation information thus obtained is checked against the definition in FIG. 2C to derive the information related to the contents of the task of the user (3E). In this example, the relation information 3C-1 corresponds to the definition 2C-D of FIG. 2C, the relation information 3C-2 corresponds to the definition 2C-C of FIG. 2C, and both of the information means the task information that “the user-3 is at manufacturing” (3E-1).

The information on the task thus obtained is stored in the context base as the structural element of the context information (3F). In this example, only the task information 3E-1 may be stored at the minimum. However, since the relation information such as 3C-1, 3C-2, and 3C-1 which have been derived on the way represents a kind of context information related to the task, those pieces of relation information can be also stored in the context base at the same time.

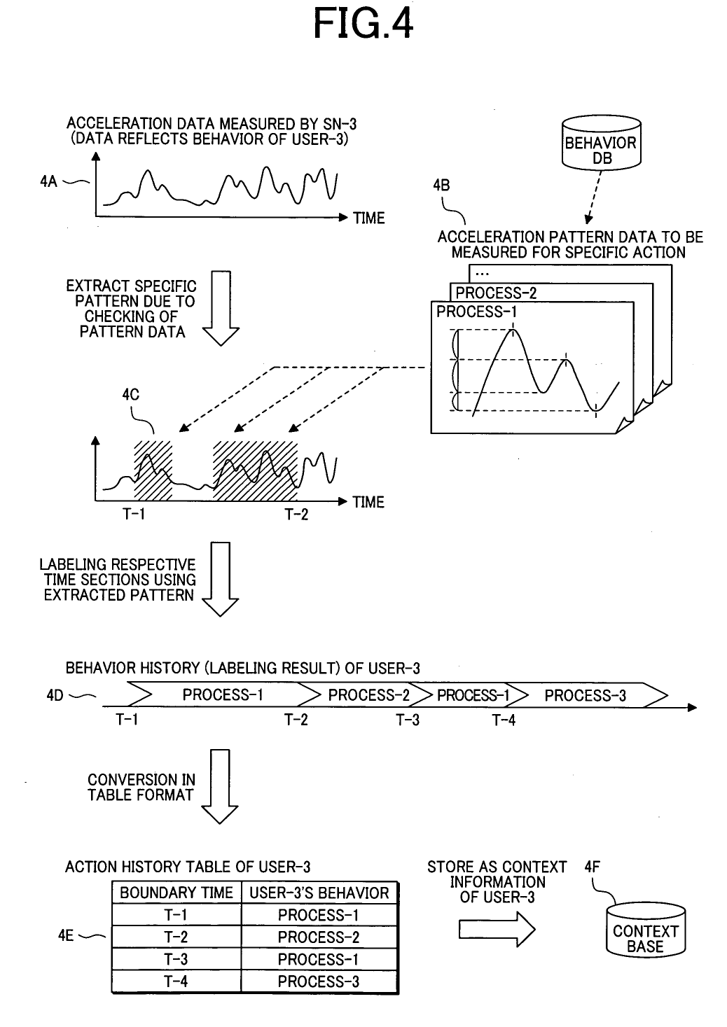

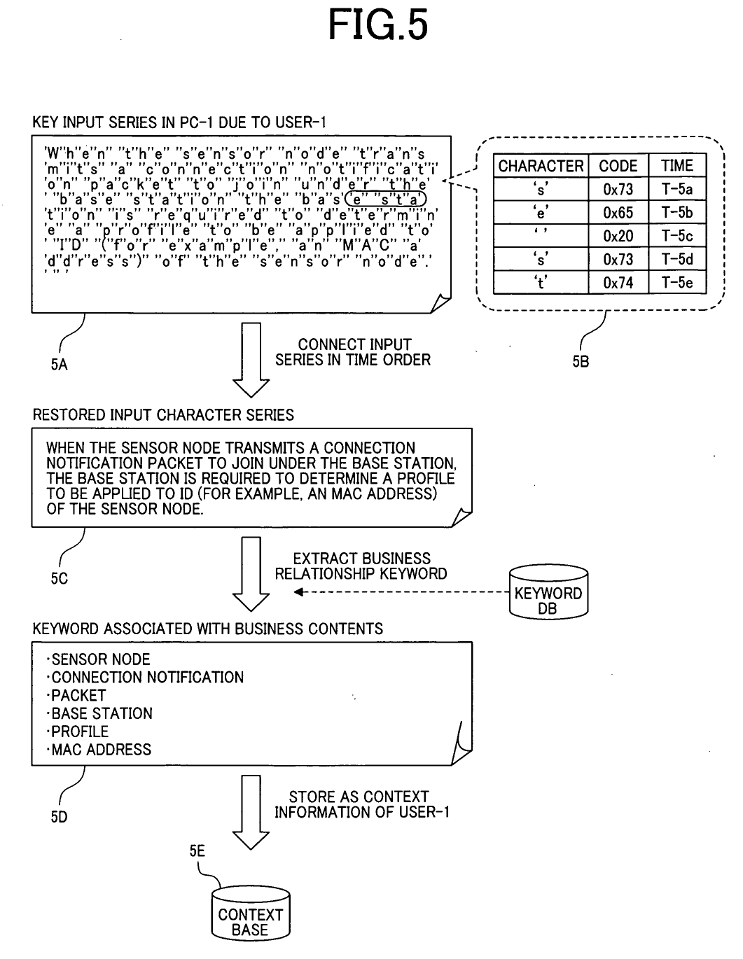

The context analyzer according to this embodiment does not only conduct the rough task estimation based on the above proximity information, but also estimate the fine behaviors of the respective users on the basis of the behavior information on the respective users and the surrounding environmental information. FIG. 4 shows a procedure of estimating the behavior of the user user-1 which is executed by the behavior analyzer within the context analyzer, and FIG. 5 shows a procedure of detecting a keyword related to the task of the user user-1 by the keystroke analyzer.

FIG. 4 shows an example in which the sensor node SN-3 estimates the behavior when the user user-3 is at manufacturing as the task, that is, estimates the finer operation history, by the aid of acceleration data that has been measured by an acceleration sensor within the sensor node SN-3.

Since the sensor node SN-3 is worn by the user user-3, the acceleration data (4A) that has been measured by the sensor node SN-3 reflects the behavior of the user user-3. On the other hand, in the behavior DB is registered typical pattern data that is measured in the respective operation processes conducted by the user at manufacturing task in advance (4B). The behavior analyzer extracts a time subsection that matches with the respective pattern data from the time series of acceleration data which has been measured by the sensor node SN-3 (4C) while referring to the pattern data (process-1, process-2, etc.). Then, the time subsections that are continuously high in the degree of correlation with respect to the pattern data of specific operation process-1 is labeled as a time section that is engaged in the process-1 in bulk. Likewise, the respective specific operation such as the process-2 and the process-3 is labeled with the result that the estimation of the detailed context of the task which is the detailed operation process while the user-3 is at manufacturing is completed in a time series fashion (4D). The information on the above operation history is converted into a treatable format, for example, a table format (4E) within the server, and then stored in the context base as information that constitutes the context of the user-3 (4F).

Subsequently, a description will be given of a procedure of detecting the keyword in real time which is related to the task of the user user-1 shown in FIG. 5.

When the user-1 conducts the task operation such as document preparation in the PC-1, the key operation that has been conducted by the user-1 is recorded by the keystroke monitor within the PC-1, and then transmitted to the server in real time. In FIG. 5, a case where the user-1 inputs English is exemplified for simplification. In this situation, the keystroke monitor records the information on the character code corresponding to the respective input characters and the time at which the respective characters are input with respect to the key input string (5A) to the PC-1 by the user-1, and then transmits the recorded information to the server as the keystroke information (5B). In this example, 5B represents the keystroke information with respect to the string including five characters consisting of s′, e′, ′, s′, and t′ which are a part of the input string 5A (′ represents a blank character). In this situation, for example, code information on the character such as s′ is 0x73 (which is generally called “ascii code”), and the time information is T-5a. The two information pieces of codes and time is the keystroke information that is actually transmitted to the server.

In the server, the keystroke analyzer within the context analyzer first connects the individual characters of the input string 5A together in a typed time order, and restores the actual character string that is input by the user (5C). Then, the keyword related to the task is extracted from the character string with reference to the keyword DB in which the keywords that are characteristically representative of the special task and the task context are stored in advance (5D). The extracted keyword is stored in the context base as the context information related to the task of the user-1 (5E).

In the keyword DB can be registered the keyword related to the task context to be extracted. In a task high in the specialty, technical terms in the field of the task can be registered. Even in the task that is not too high in the specialty, since the characteristic expressions which represent the context of the task exist in many cases, such general keywords can be registered. For example, in the case of a material procurement task, keywords such as “material”, “procurement”, “order”, “approval”, “contract”, and “settlement” can be employed. Alternatively, as described in FIGS. 2A to 2C, the names of articles strongly related to a specific task (manufacturing in this example) such as a small tool and large equipment can be registered. In this way, there is no limit of the type or meaning in the keywords that are registered in the keyword DB, and any words can be registered when the words are characteristic words that will be input in the task context to be detected by the user.

The input string 5A shows an example in which the user user-1 inputs writing in an ideal procedure without making a typo for facilitation of understanding. However, in the key input in the actual PC operation, because it is usual that the operation of moving an input line or correcting the mistyped character later occurs at a reasonable frequency, control characters such as a move key or backspace are included in a raw input string, which is attributable to the correcting operation. Moreover, because the above operation is recorded without any change in a time series fashion, a final writing that has been input by the user user-1 is not faithfully reproduced in the restored character string 5B. As compared with a case using the final writing, a rate at which the words can be extracted as correct words is also reasonably reduced. However, keywords to be extracted are keywords characteristic of the specific task context, and such keywords or other keywords similar to those keywords are frequently input not once but repetitively. Accordingly, it can be expected to extract the necessary keywords with a sufficient efficiency in a practical use even from the raw input string including many pieces of waste information described above.

As described above, the keystroke analyzer conducts only simple processing such as the coupling of the time-series data or the keyword matching, and does not require such complicated processing as to restore the final writing or parse the entire writing. However, there are great advantages in implementation and practical use in that the context related to the task in real time can be efficiently extracted.

FIG. 5 shows a case in which the user user-1 inputs English. In the case of a language that is different between a code (key code) that occurs when the keyboard is typed and a code (character code) which is actually input as the writing as in Japanese or Chinese, the character code can be applied as a code (not a key code) which is recorded by the keystroke monitor. The conversion between the key code and the character code in the above language is normally conducted by language input software included with an operating system (OS), which is called “input method editor (IME)” or “front end processor (FEP)”. Accordingly, the keystroke monitor is required to only record the character code which is output from the language input software even if any languages are applied, and is required to have only the simple recording function and transmitting function as in the processing in FIG. 5. In the case where the character code used at the PC side is different from the character code used in the key words that is stored in the keyword DB in a language having plural character codes (JIS code, shift-JIS code, EUC code, and UTF-8 code) as with Japanese, it is necessary that any one of the keystroke monitor and the keystroke analyzer has a function of converting each other's character codes.

Also, as the related art, there can be applied a technique in which the key word is extracted by analyzing the writing included in the document that is presently produced or viewed in the PC-1 by the user-1 as disclosed in JP-A No. 2007-108813. In this case, not only the keyword that has been input by the user-1 but also the keyword included in writing made by another person are widely to be extracted, and there is a characteristic that the amount of character string to be searched becomes enormous as compared with that in the present invention. In order to effectively utilize the characteristic, it is preferable to further include means for narrowing down the keywords that are really high in the association with the user-1, and parsing means for extracting only noun phrases in the PC-1 so as not to increase communication data volume. With the above configuration, it is possible to efficiently extract the keywords that are high in the association with the user-1 by the aid of the wide data to be searched.

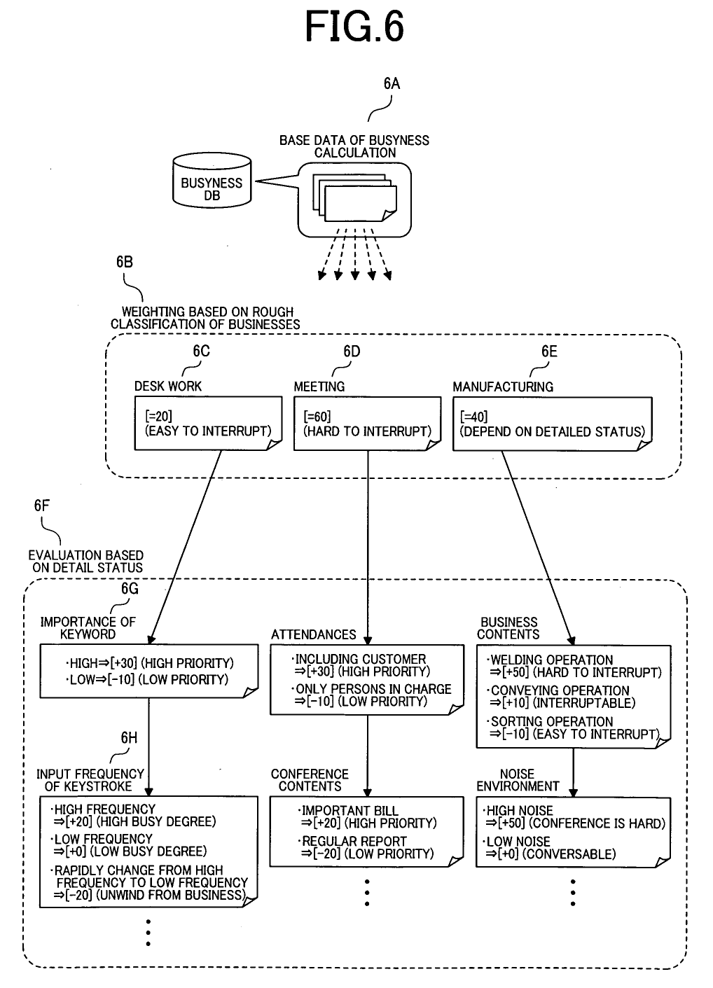

FIG. 6 shows basic data for calculating a busyness value that is stored, and a procedure of calculating the busyness on the basis of the basic data by the busyness evaluator, in the busyness DB and in the system of this embodiment.

As the definition of the busyness, the busyness is, for example, so defined as to represent the costs for temporarily interrupting the task at a certain time to take such a behavior as to reply to a call. The busyness is numerically expressed in percentage, and the costs for replying to the call are larger as the value is larger. That is, the busyness can be defined to express the busier context.

The busyness evaluator inputs the context information related to the user's task, which is detected by the model analyzer, the behavior analyzer, and the keystroke analyzer, and stored in the context base. The busyness evaluator calculates the busyness value of the respective users on the basis of the input information with reference to the basic data (6A) for calculating the busyness value which is defined in association with the coarse classification of the task and the detailed context in advance and stored in the busyness DB.

As a specific procedure, the busyness evaluator first refers to the busyness DB on the basis of the coarse classification (deskwork, meeting, or manufacturing) of the tasks of the respective users which is detected by the model analyzer to comprehensively weight the busyness values of the respective users (6B). For example, in the case where the task that is the deskwork is evaluated in the large sense, it is relatively easy to temporarily interrupt in order to reply to the call. For that reason, the comprehensive busyness value is defined by a small value such as 20 (6C). On the other hand, in the case of a meeting, there is frequently required that consideration for the others around the partner is needed, such as the partner temporarily leaving the meeting room, and it is relatively difficult to reply to the call when evaluation is comprehensively conducted. For that reason, the comprehensive busyness value is defined by a large value such as 60 (6D). Also, in the case of manufacturing, an interruption may be conducted without any problem or no interruption may be conducted at all, depending on the operation contents, for which there is no cut and dry answer. For that reason, the comprehensive busyness value is defined by an intermediate value such as 40 (6E).

After the comprehensive weighting has been conducted on the basis of the coarse classification of the task as described above, the evaluation is conducted. Thereafter, the busyness evaluator refers to the busyness DB on the basis of the detailed context of the task which has been detected by the behavior analyzer or the keystroke analyzer to conduct the detailed evaluation of the busyness values of the respective users (6F). FIG. 6 shows the partial detailed evaluation. In the case of the comprehensive task such as deskwork, when a large number of important key words are detected by the keystroke analyzer, it is possible to evaluate that the user is engaged in the task high in the importance, as a result of which a value of 30 is added to the comprehensive busyness value that has been calculated in advance (6G). At the same time, an evaluation is conducted on the basis of the input frequency of the keystroke of the user. In the case where the input frequency is high (the pace of the key input is high), it is possible to evaluate that the user is busy with the result that a value of 20 is further added to the busyness value (6H). Similarly, the evaluation based on the detailed context when the user is engaged in the comprehensive task such as the meeting or the manufacturing operation can be also executed.

In this embodiment, the busyness evaluator conducts double procedures, that is, first comprehensively weights the busyness value on the basis of the comprehensive task context that is detected by the model analyzer, and thereafter conducts the detailed evaluation of the busyness value on the basis of the detailed task context that has been detected by the behavior analyzer and the keystroke analyzer. This is a devise for flexibly calculating the busyness value according to a precision in the task context that could be calculated because the task contexts of the respective users cannot be always completely calculated.

More specifically, in the case where the measurement information of the sensor cannot be gathered with a sufficient resolution, or the user takes an untypical behavior although the information content is sufficient, the behavior analyzer or the keystroke analyzer cannot precisely estimate the detailed context of the user. As a result, there can occur such a case in which the user knows only the information on the coarse classification of the task which is detected by the model analyzer.

Conversely, when the measurement information of the sensor is sufficient, but the information on the proximity communication is insufficient, there can occur a case in which the user knows the very fine context of the task, but does not know the comprehensive context. Even in this case, there is taken the procedure of dividing the task into the comprehensive classification and the detailed context to evaluate the busyness value step by step as in this embodiment. As a result, even in the case where any one of the information on the coarse classification and the detailed context is missing, it is possible to flexibly calculate the busyness value having a reasonable reliability with a lead of the obtained incomplete information. As described above, this embodiment has a very flexible and robust mechanism for evaluating the user's context, and can constitute an extremely practical system.

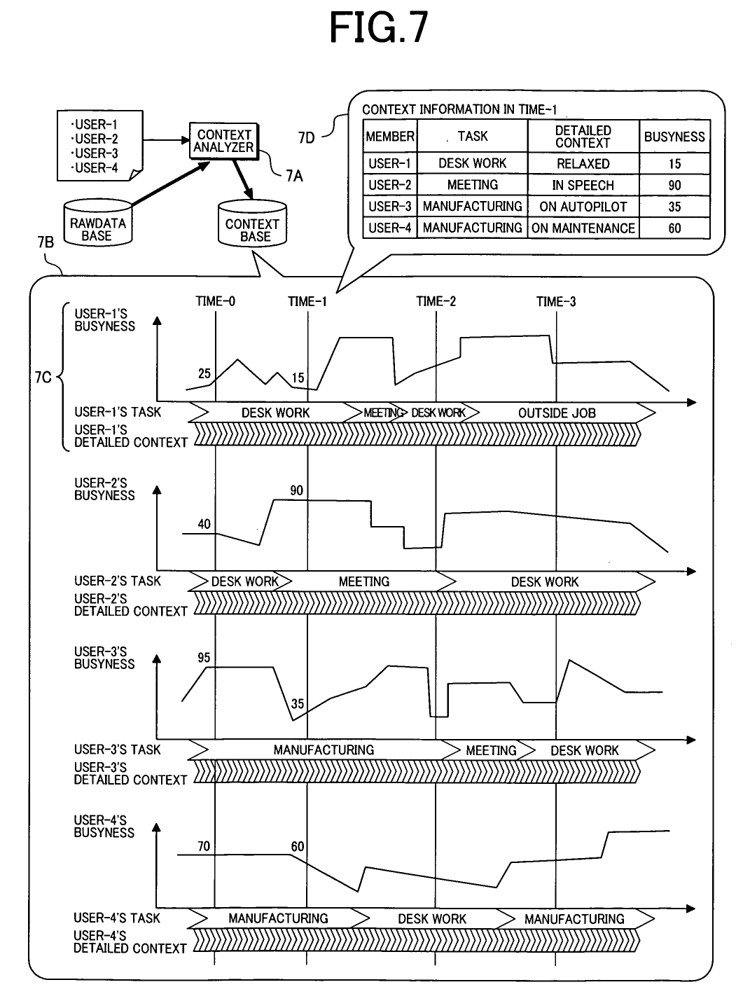

FIG. 7 shows the details of the context information on the respective users user-1 to user-4 which is stored in the context base with a time by the operation of the context analyzer.

The raw measurement data that has been input to the raw data base is subjected to processing shown in FIGS. 3 to 6 in the context analyzer, as a result of which the information on the tasks of the respective users user-1 to user-4 which is registered in the member list, and the information on the occasional busyness value are calculated, and the information is momentarily stored in the context base (7A). The figure shows an example of a time-series change in the information on the user-1 to user-4 which is stored in the context base (7B). The information on the respective users includes the information on the task as the coarse classification, the information on the detailed context of the task, and the information on the busyness, and the time-series transition of those pieces of information is stored (7C). For example, it is understood from the transition of the user-1's task that the user-1 has such a schedule as to first conduct the deskwork, then attend a meeting, and again conduct the short-time deskwork before going to an outside job. It is understood from the transition of the busyness value at that time that a time zone during which the user is engaged in the deskwork is in a context where the user is roughly easy to receive a notification, and time zones of the meeting and the outside job are difficult to receive a notification. Because other users also autonomously execute the tasks, respectively, the transition of the tasks of the respective members and the transition of ease in receiving the notification which is indicative of the busyness value are asynchronous as a whole.

In this example, when the detail (7D) of the context information at a time time-1 is specifically viewed, the task of the user-1 is deskwork, the detailed context is relaxed, and the busyness value is 15. Likewise, the task of the user-2 is a meeting, the detailed context is in speech, and the busyness value is 90. The task of the user-3 is manufacturing, the detailed context is on autopilot, and the busyness value is 35. The task of the user-4 is manufacturing, the detailed context is on maintenance, and the busyness value is 60. The time time-1 is a time zone when the busyness values of both of the user-1 and the user-2 are sufficiently small, that is, it means that the time-1 is a time zone that is most convenient in having a contact with each other.

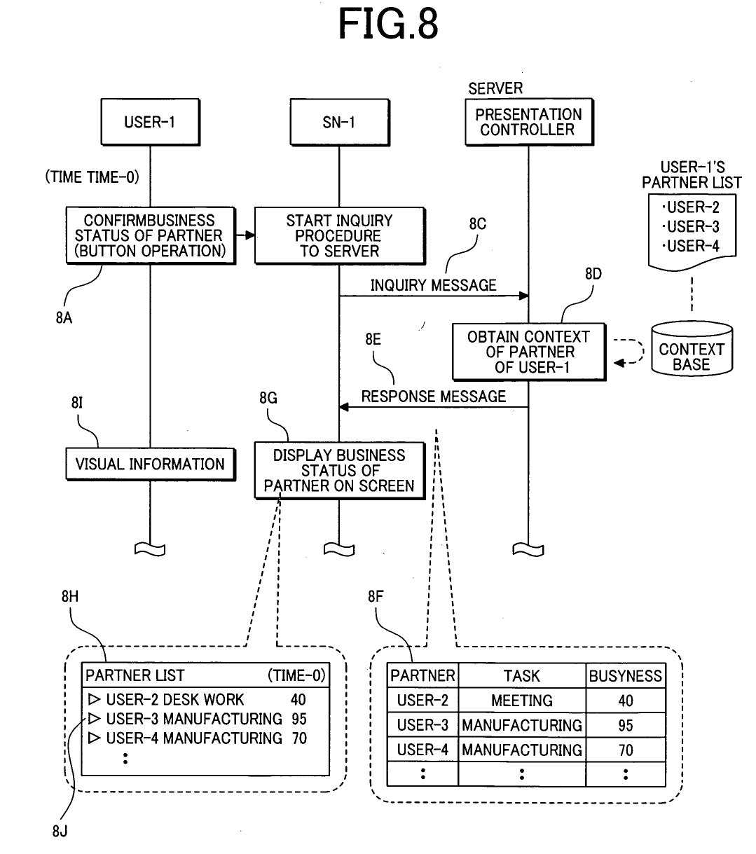

FIG. 8 shows a procedure of obtaining the context information on the respective members by the user-1 in a context where it is necessary that the user-1 has a contact with a member related to the user-1, and an example of a display screen in the wearable sensor node SN-1.

It is assumed that there occurs a necessity of giving an inquiry or a request with respect to the use-3 in the tasks of the user-1. In the case of a business that really requires an emergency, even when the user-3 is now in the execution of another important task, the user-1 will forcedly call the user-3 in an interrupting manner, or will go to meet directly with the user-3. However, in this example, it is assumed that there is a general business that is not specifically high in the emergency as in the case where an e-mail is utilized in the conventional art. In this case, because the context of the partner is not known in the conventional art, the user calls the partner at timing where the partner is absent in vain, or the user is in a psychological state where the user hesitates to allow the task of the partner to be interrupted, which makes difficult for the user to call the partner. As a result, this leads to such a problem that the necessary communication is insufficient, or the necessary communication is unintentionally suppressed. Also, the e-mail is seemingly the conventional art that produces the optimum effect in the above context. However, the e-mail requires text input, and the production of writing while spending time several time as much as that in the business that is dealt with by a simple conversation makes the efficiency very low, and in the case where there are many communication items, the task efficiency of the user is resultantly lowered. In the above circumstances, the system according to this embodiment can facilely realize a sound communication with simple communication without lowering the task efficiency of the user and the task efficiency of the partner, thereby exercising a great effect.

First, referring to FIG. 8, it is assumed that the user-1 intends to have a communication with the user-3 at around a time time-0. In this situation, the user-1 operates the wearable sensor node SN-1 that is worn by the user-1 so as to obtain the task context of the partner who is a member related to the user-1's task (8A). With the above operation, an inquiry procedure to the server starts in the sensor node SN-1 (8B), and a message that inquires the task context of the partner of the user-1 is transmitted (8C). The message is received by a presentation controller in the server, and the present task context (a time of time-0) of members who have been registered in the partner list (user-1's partner list) of the user-1 is acquired from the context base (8D). The acquired information is returned to the sensor node SN-1 as a reply message to the inquiry message 8C (8E). The reply message 8E includes information representative of each and every name of the partners of the user-1, information on the present task, and the information on the present busyness (8F). The sensor node SN-1 that has received the reply message 8E has its information displayed on a screen (8G). When the information is displayed on a small screen of the wearable sensor node, it is preferable to display the names of the respective partners, the tasks, and the busyness on the character basis in brief (8H). The user-1 visually recognizes the display (8I), thereby making it possible to confirm the tasks of the respective partners including the user-3.

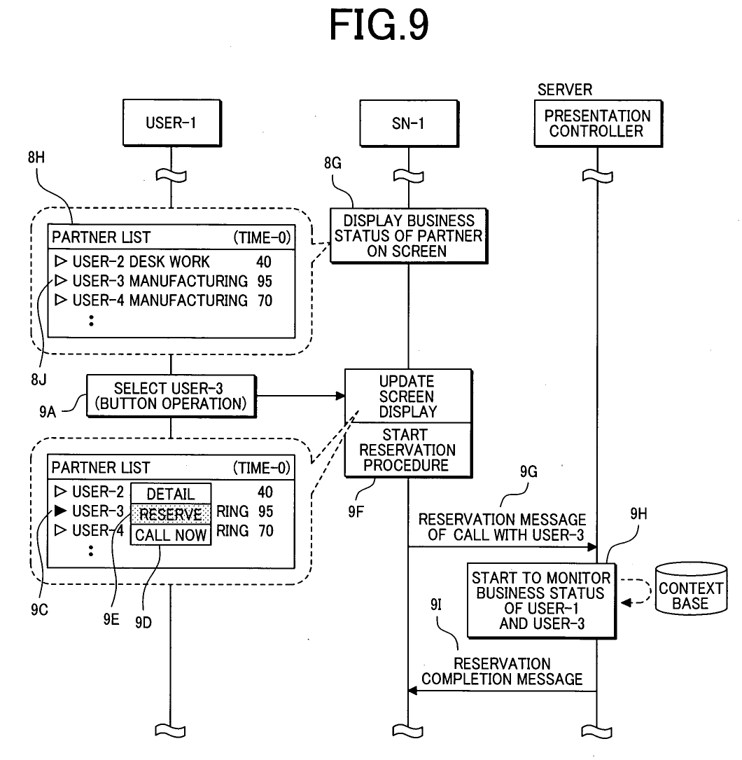

FIG. 9 shows an operating procedure when the user-1 reserves a communication with the user-3, and an example of a display screen in the wearable sensor node SN-1 as operation subsequent to that in FIG. 8.

A screen display 8H that displays the task information of the partner of the user-1 is added with a triangular mark at a left side of the names of the respective partners (8J). This shows that some operation can be conducted on the respective partners. In this example, the user can select the respective items added with the mark, and instructs an action to the selected items through the button operation. In this example, when the user-1 conducts the button operation to select the user-3 who is a partner to be communicated (9A), the screen display of the SN-1 is updated (9B), and the mark added on the left side of the name of the user-3 is displayed by highlight (9C). Further, a list of the actions that can be designated with respect to the user-3 is displayed (9D). In this example, the busyness value of the user-3 is 95 at that time (a time of time-0) is 95, and it is expected that the user-3 is in a very busy context. For that reason, the user-1 does not communicate with the user-3 at that time, and instead selects “reserve” that means a reservation of a call to the user-3 (9E). Then, a procedure for executing the reservation starts (9F), and a message that reserves a communication with the user-3 is transmitted to the server (9G). When the presentation controller receives the reservation message in the server, the presentation controller starts to monitor the task contexts of the user-1 and the user-3 (9H), and returns a reservation completion message to SN-1 (9I).

After the procedure 9H, the presentation controller continues to monitor the context base until the busyness values of both the user-1 and the user-3 become sufficiently small.

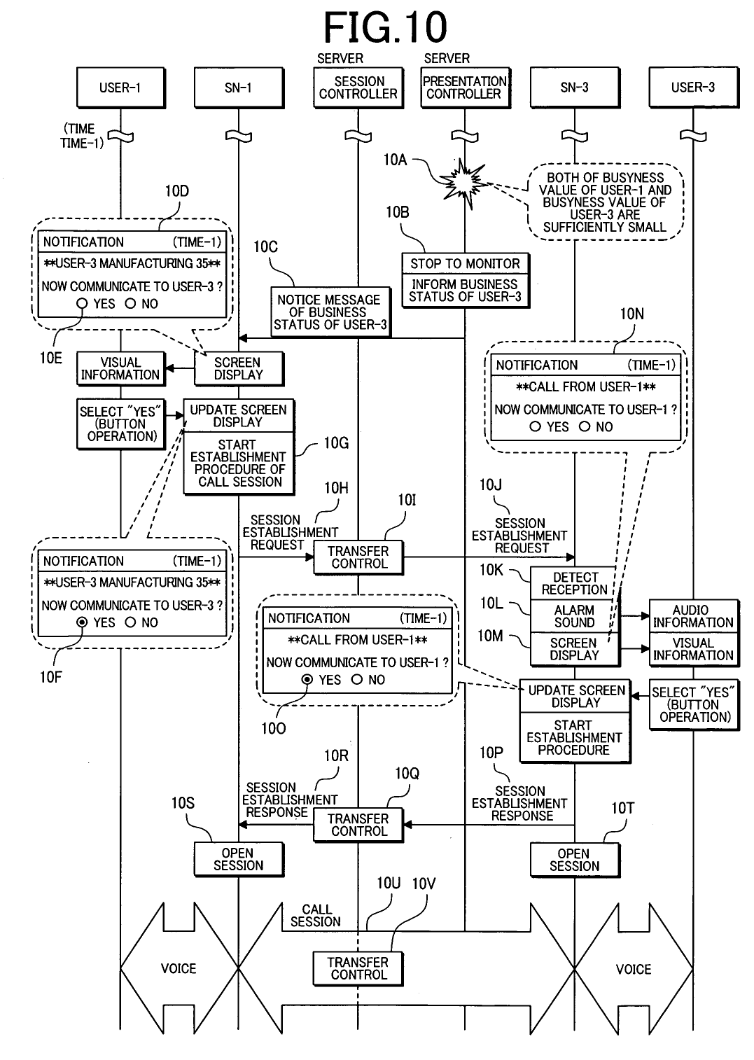

FIG. 10 shows the operation until the condition for a call to the user-3 is met, and the call actually starts as operation subsequent to that in FIG. 9.

When the time reaches about time-1, both of the busyness values of the user-1 and the user-3 become sufficiently small, which is detected by the presentation controller that has continuously monitored the busyness values after the procedure 9H (10A). In this situation, the presentation controller stops the monitor (10B), and transmits information indicative the task context of the user-3 to the sensor node SN-1 (10C). This information is displayed on the screen of the sensor node SN-1, and the user-1 is facilitated to select whether a call to the user-3 starts, or not, at the same time (10D). In the display information 10D, that the present task (time of time-1) of the user-3 is manufacturing operation, and that the busyness value is 35 are displayed. In addition, a question message (Now communicate to user-3?) which inquires whether the user-1 starts the call to the user-3, or not, and a circle mark indicating that any one of “yes” and “no” can be selected in response to the inquiry message are displayed (10E).

When the user-1 selects “yes” through the button operation (10F), an establishing procedure of the call session starts (10G), and a message that requests the session establishment with the user-3 is transmitted to the server (10H). In this example, the message 10H is addressed to the user-3, but because the sensor node SN-1 does not know which device a session should established with in order to call the user-3, this message is transmitted as a request message to the server. Within the server, the session controller receives this message, and determines that the session should be established with the sensor node SN-3 in order to call the user-3 on the basis of the definition information shown in FIG. 2A (10I), and transfers a message of a session establishment request to the sensor node SN-3 (10J).

The sensor node SN-3 that has received this message identifies the reception of a call (10K), issues an alarm sound (10L), and displays a screen that announces the reception (10M). On the display screen 10N, a message (call from user-1) indicative of the reception from the user-1 as well as a question message (Now communicate to user-1?) which inquires whether the reception is allowed, or not, and an option for the question message are presented by “yes” and “no”. The user-3 selects “yes” to return the reply message for establishing the session to the server (10P). In this example, the message 10P is addressed to the user-1, but because the sensor node SN-3 does not know which device the session is to be established with in order to call the user-1, this message is transmitted as a request message to the server. Then, it is determined by the session controller within the server that the return address is the sensor node SN-1 (10Q), and a message of the session establishment reply is transferred to the sensor node SN-1 (10R). At that time, a sound session is opened by both of the SN-1 and the SN-3 (10S, 10T), and the subsequent sound session starts (10U). As in the procedures 10I and 10Q, in the sound session 10U, the session controller mediates a communication between the sensor node SN-1 and the sensor node SN-3 (10V).

As shown in the procedures 10I, 10Q, and 10V, in this embodiment, a communication between the sensor node SN-1 and the sensor node SN-3 always goes through the server. The session controller identifies a destination physical address from the user information, thereby making unnecessary that the both of the sensor node SN-1 and the sensor node SN-3 know the respective physical addresses. When the sensor node communicates with any of the devices, the sensor node is required to communicate with the server, a route control in the respective sensor nodes and a base station is remarkably simplified, and a design of the control logic of those small equipments is facilitated. Likewise, since those physical addresses are completely concealed from the user, it is unnecessary that the user is aware of the address information specific to the communication means such as a telephone or an e-mail, and a communication partner is required to be simply selected.

In the flows of FIGS. 8 to 10 which are described above in detail, the operation of the system in this embodiment in a context where the user per se wants to communicate with a specific person is described. In another embodiment that will be described below, in a context where the user per se is not aware of the necessity that the user communicates with someone, the necessity of a potential communication is automatically found, and the user is awakened to this face from the system side, to thereby realize new collaboration creation or close information sharing within the organization, which has not been realized conventionally.

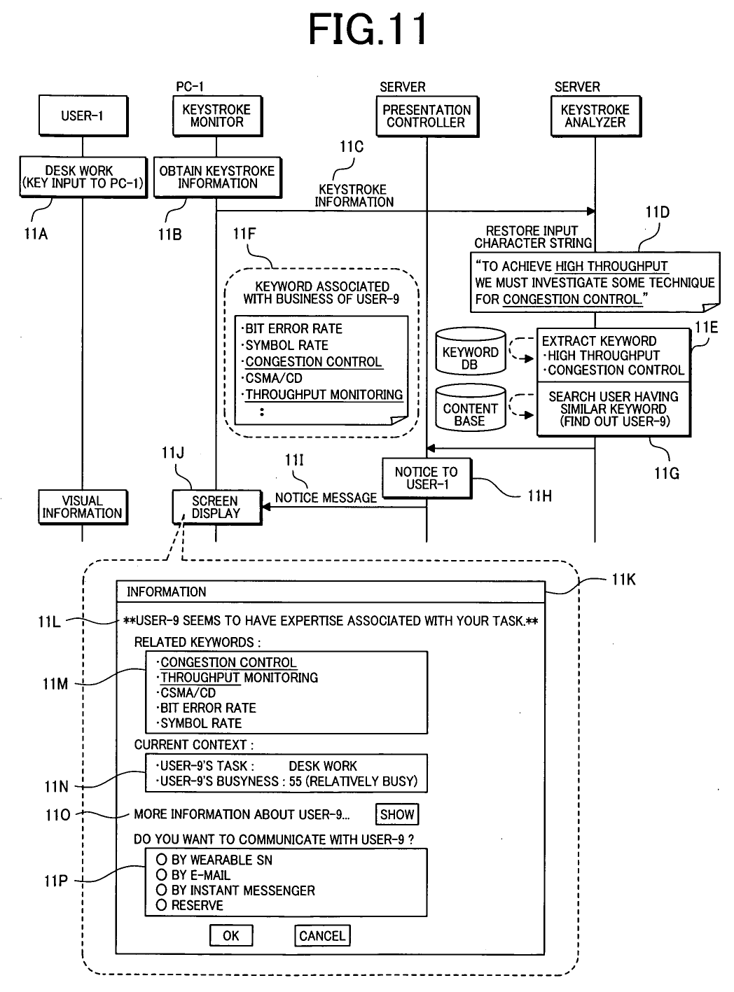

FIG. 11 shows the operation of another embodiment in the case of presenting the information of a member having the detailed knowledge of the task contents of the user user-1 in this system.

While the user-1 is conducting the deskwork, the key input (11A) of the user-1 is monitored by the keystroke monitor that is installed in the PC-1 (11B), and then gathered in the server (11C). In the server, the input character string is restored by the keystroke analyzer (11D). In this situation, it is assumed that technical words of “high throughput” and “congestion control” are included in the writing that has been input by the user. The keystroke analyzer refers to the key word DB, and attempts to extract the key word related to the task from the writing, as a result of which the above two technical words are extracted (11E).

The keystroke analyzer that is executed by the CPU of the server then searches the context base, and searches whether the key words related to those two technical words are included in the key words of another user, or not. In this situation, it is assumed that the completely same keyword as “congestion control” and the similar key word having the same word as “throughput monitoring” are found in the key words (11F) related to the task of the user user-9 (11G). Then, the presentation controller within the server transmits a notification message (11I) to the PC-1 which is used by the user-1 (11H), presents that it appears that a user-9 has a detailed knowledge of a field on which the user-1 is engaged (11L), and awakens the user-1 to the information exchange (11J). On the screen displayed on the PC-1 (11K), the key word (11M) related to the task of the user-9 as well as the information (11N) on the present task and busyness value is displayed. Therefore, the user-1 can determine whether the user-1 should just now communicate with the user-9, or should communicate with the user-9 later on the basis of the information.

Since the user-1 had not been aware of the necessity of the communication with the user-9 before, the psychology of a hesitation to interrupt the task of the user-9 by calling the user-9 becomes high as compared with a case in which the user-1 has been aware, and there is the possibility that the simple presentation of the existence of the user-9 does not develop into the actual collaboration. In this case, the advantage of the present invention that the user is capable of communicating with the partner at an opportune time for the partner more remarkably appears. The psychology of the hesitation is removed, thereby making it possible to satisfy new collaboration that had never been executed up to now. As a result, it can be expected that the productivity and creativity of the entire organization are remarkably improved.

Also, since a link to the detailed information on the user-9 is also presented on the screen 11K of the PC-1 of the user (user-1), even if the user-1 has no acquaintance with the user-9, the user-1 can confirm the detailed information on the affiliation of the user-9 or a task in his charge quickly. Also, in the case where both of the user-1 and the user-9 are engaged in deskwork, it is possible to use not only the wearable sensor node but also a conventional means such as an e-mail or an instant messenger. Under the circumstances, the screen 11K presents plural options as the communicating means, and also presents an option that makes a reservation for a communication after as described with reference to FIG. 9 (11P). In this way, in the environment where the plural communicating means can be employed, means preferred by the user can be selected with the result that the applied field of the present invention can be further extended in combination with the conventional art.

In this example, the screen 11K is shown by an image of an independent drawing window for facilitation of understanding. In the case where the drawing window is frequently popped up, there is a risk that the writing input of the user-1 is interrupted, and the task efficiency is deteriorated. Accordingly, as a specific method of the screen display 11J under Article PC-1, it is desirable to make an arrangement that the deskwork of the user-1 is not interrupted while the presentation information is effectively notified. For example, a method is effective in which a sub-area for information presentation is disposed at edges of the screen, and the presence/absence or abstract of the presentation information is displayed in the sub-area, and the more detailed information is displayed only when the user-1 selects the sub-area.

As described above, according to the present invention that has been described in detail with the respective devices of the user collaboration system, and the server used in the system with reference to the specific embodiments, there can be realized a facile communication tool that can quickly communicate with a necessary partner when needed. Also, since the system presents an opportune time for both of the user and the partner, and the partner who is potentially high in association with the user in real time, a communication can easily start with the presentation as a trigger, as a result of which the information sharing or the collaboration as the entire organization become tight, and the productivity of the organizational task can be improved.

What is claimed is:

1. A user collaboration system that realizes a communication between a plurality of users, the user collaboration system comprising:
a detector that detects the user contexts of respective users in real time; and
a processor that determines the busyness of tasks of the respective users based on the user contexts detected by the detector,
wherein the communication between the users is controlled on the basis of the determined busyness.

2. The user collaboration system according to claim 1, wherein the processor notifies one of the users of the task or the busyness of another of the users.

3. The user collaboration system according to claim 1, wherein the processor detects timing when the busyness of selected first and second users is lower than a given value, and notifies the first and second users of the timing.

4. The user collaboration system according to claim 3, wherein the notified first and second users start a call on the basis of the notified timing.

5. The user collaboration system according to claim 1, wherein the processor detects the second user that is high in the association with the task of the first user, and notifies the first user of the detected second user.

6. The user collaboration system according to claim 1, wherein the detector includes a first sensor node that is worn by the user, and a stationary second sensor node, and
wherein the processor estimates the task of the user from outputs of the first and second sensor nodes.

7. A user collaboration system that realizes a communication between a plurality of users, the user collaboration system comprising:
a sensor node that detects the user contexts of the respective users; and
a server including a communication unit, a memory, and a processor,
wherein the communication unit receives the user contexts of the respective users which are detected by the sensor node on a network, and
wherein the processor determines the busyness of the task of the user on the basis of the received user context.

8. The user collaboration system according to claim 7, wherein the processor notifies one of the users of the task or the busyness of another of the users.

9. The user collaboration system according to claim 7, wherein the processor detects timing when the busyness of first and second users is lower than a given value, and notifies the first and second users of the timing.

10. The user collaboration system according to claim 7, wherein the processor detects the second user that is high in the association with the task of the first user, and notifies the first user of the detected second user.

11. The user collaboration system according to claim 7, wherein the processor stores a task definition related to the task, and
wherein the processor includes a model analyzer that extracts the task of the user on the basis of the stored task definition and the received user context.

12. The user collaboration system according to claim 11, wherein the memory stores a predetermined busyness database according to the contents of the task, and
wherein the processor includes a busyness evaluator that evaluates the busyness of the extracted task by the aid of the stored busyness database.

13. The user collaboration system according to claim 12, further comprising a keystroke monitor that detects the key input of the user,
wherein the processor includes a keystroke analyzer that receives keystroke information that is output by the keystroke monitor, and analyzes the detailed context of the task, and
wherein the busyness evaluator estimates the comprehensive busyness from the extracted task by the aid of the busyness database, and estimates the detailed busyness from the detailed context of the task which is analyzed by the keystroke analyzer.

14. The user collaboration system according to claim 12, wherein the sensor node comprises an acceleration sensor that outputs acceleration data,
wherein the processor includes a behavior analyzer that receives the acceleration data that is an output of the acceleration sensor, and analyzes the detailed context of the task, and
wherein the busyness evaluator estimates the comprehensive busyness from the extracted task by the aid of the busyness database, and estimates the detailed busyness from the detailed context of the task which is analyzed by the behavior analyzer.

15. A server that realized a communication between a plurality of users, the server comprising:
a communication unit that receives the user contexts of the respective users which are detected by the detector in real time; and
a processor that determines the busyness of the respective users on the basis of the user context.

16. The server according to claim 15, wherein the processor notifies one of the users of the task or the busyness of another of the users.

17. The server according to claim 15, wherein the processor detects timing when the busyness of selected first and second users is lower than a given value, and notifies the first and second users of the timing.

18. The server according to claim 15, wherein the processor detects the second user that is high in the association with the task of the first user, and notifies the first user of the detected second user.

19. The server according to claim 15, wherein the processor stores a task definition related to the task, and
wherein the processor includes a model analyzer that extracts the task of the user on the basis of the stored task definition and the received user context.

20. The server according to claim 15, wherein the memory stores a predetermined busyness database according to the contents of the task, and
wherein the processor includes a busyness evaluator that evaluates the busyness of the extracted task by the aid of the stored busyness database.
